(19) United States
(12) Patent Application Publication
(10) Pub. No.: US 2005/0220593 A1
(43) Pub. Date: Oct. 6, 2005

(54) Vehicle for receipt and discharge of separate matter

(76) Inventor: Robert Stephen MacPherson, Ajax (CA)

Correspondence Address: BIRCH STEWART KOLASCH & BIRCH, PO BOX 747, FALLS CHURCH, VA, 22040-0747, US

(21) Appl. No.: 11/022,637

(22) Filed: Dec. 28, 2004

(30) Foreign Application Priority Data
Dec. 29, 2003 (CA) 2,454,330

(51) Int. Cl. B65F 3/02

(52) U.S. Cl. 414/525.52

(57) ABSTRACT

The vehicle has a loading floor for receipt of separate matter such as refuse and recyclables and a container for the matter. A sweep blade moves between inner and outer stop positions. When the blade moves from the inner stop position, it extends outwardly of the container and terminates at the outer stop position at which the blade is in contact with any matter on the loading floor. When the blade moves from the outer stop position, it retracts inwardly through an opening in the container with resulting sweeping of the matter through the opening and into the container. When the blade is at the inner stop position, it is located such as to prevent any matter within the container from discharging thorough the opening. The container has a number of compartments for each category of matter and a hopper.

### FIELD OF THE INVENTION

This invention relates to vehicles for collecting refuse and recyclables and more particularly to a vehicle having compartments for segregating various categories of recyclables and refuse and for discharging the various categories separately.

### BACKGROUND OF THE MENTION

The method and disposal of waste matter has changed greatly over the past decade. Not many years ago, all waste, whatever its characteristics, was simply collected and disposed of at a land fill site or an incinerator. No longer is this the case. Nowadays, most waste is sorted into various categories, usually before it is collected, and is disposed of by different methods suited to the properties of the waste.

The categories of waste have become more numerous in recent time and there is a need to provide means by which waste in these various categories can be collected in a single vehicle. To this end, the vehicle must have separate compartments for the various categories of waste. In addition the vehicle must have means for discharging the various categories of waste separately so that the waste need not all be discharged at one location but may be discharged at various locations. Such a vehicle eliminates the necessity of sorting the waste after it has been collected. It also eliminates the need for a number of vehicles to deliver the various categories of waste to separate locations where disposal of refuse takes place or where recycling of those categories of waste occurs. One such vehicle carries out both of these functions i.e. to collect the waste and to deliver it to where it is disposed of or is recycled.

### SUMMARY OF THE INVENTION

I have invented such a vehicle. Briefly the vehicle of my invention comprises a vehicle for receipt and discharge of separate matter including: a loading floor for receipt of the separate matter; a container having a compartment for the separate matter. The compartment has an opening in communication with the loading floor and an end wall spaced apart from the opening. A sweep blade is associated with the container. Means is provided for causing the blade to move between inner and outer stop positions. When the blade moves from the inner stop position, it extends outwardly and terminates at the outer stop position at which the blade is in contact with any separate matter on the loading floor. When the blade moves from the outer stop position, it retracts inwardly through the opening and toward the inner stop position with resulting sweeping of any separate matter so contacted toward the end wall. When the blade is at the inner stop position, it is located such as to prevent any separate matter within the compartment from discharging thorough the opening.

### DESCRIPTION OF THE DRAWINGS

The vehicle of my invention is described with reference to the accompanying drawings in which:

FIG. 1 is a side view of a vehicle having a main body for recyclables and refuse, a hopper and a cab;

FIG. 2 is a perspective view of the main body and the hopper in a loading position;

FIG. 3 is another perspective view of the main body and the lower portion of the hopper;

FIGS. 4A, B and C are elevations of various positions of the unloading mechanism as it transfers recyclables and refuse from the hopper to the main body;

FIG. 5 is a perspective view of the main body and the hopper in an unloading position;

FIG. 6 is a perspective view of the hopper and a portion of the interior of the main body;

FIG. 7 is a perspective view of the main body from the rear;

FIG. 8 is another perspective view of a portion of the interior of the main body;

FIG. 9 is a perspective view of the hopper;

FIG. 10 is a perspective view of the interior of the hopper;

FIG. 11 is a perspective view of the ram mounted within the main body; and

FIG. 12 is a perspective view of the frame of the ram.

Like reference characters refer to like parts throughout the description of the drawings.

### DETAILED DESCRIPTION OF PREFERRED EMBODIMENT

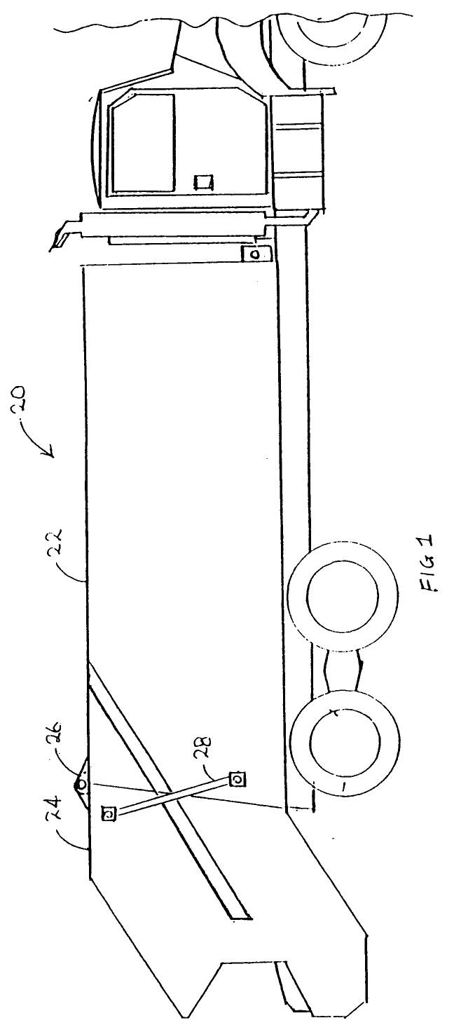

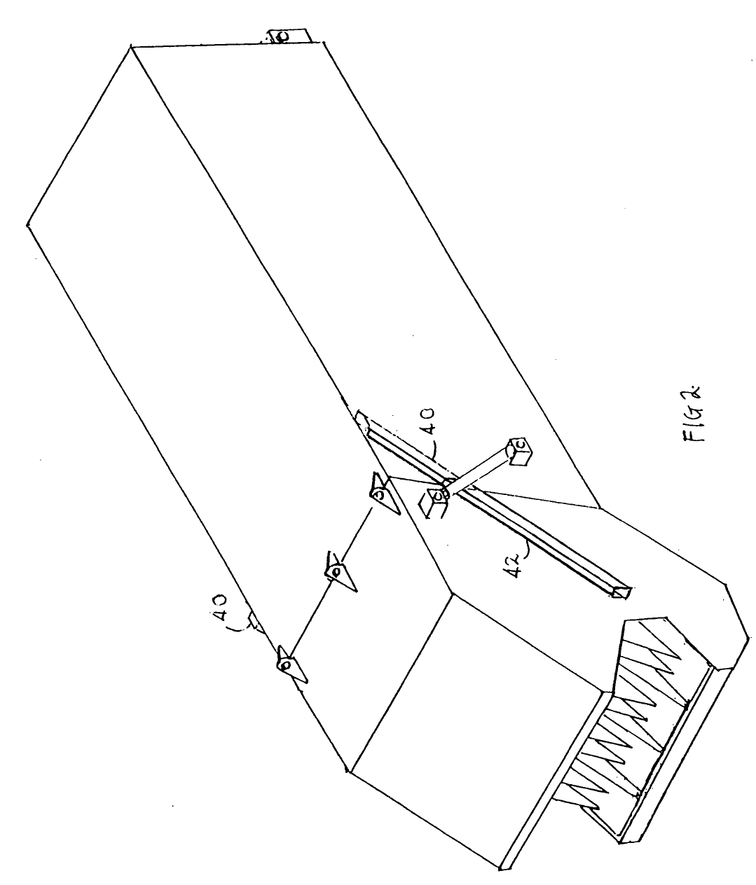

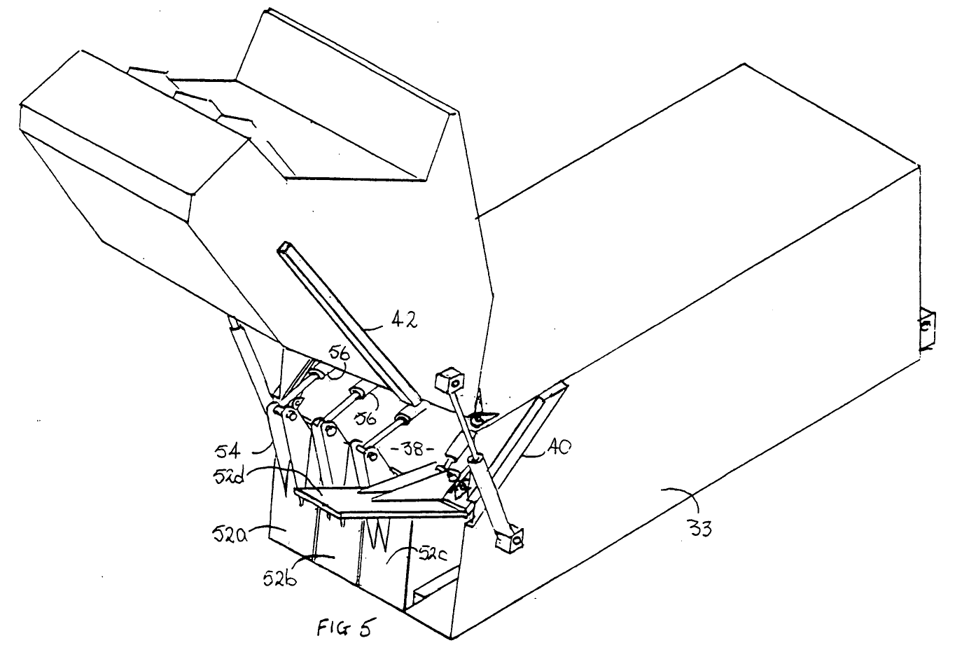

With reference to FIGS. 1, 2 and 5, a truck for collecting recyclables and refuse, generally 20, has a main body 22 for the recyclables and refuse and a hopper 24 which is attached to the roof of the main body by means of a hinge 26. An actuator 28 is attached to the main body and the hopper. The actuator serves to raise the hopper, in the usual manner, from a loading position as illustrated in FIG. 2 to an unloading position illustrated in FIG. 5. In the latter position, the hopper is out of the way when the contents of the main body are being discharged.

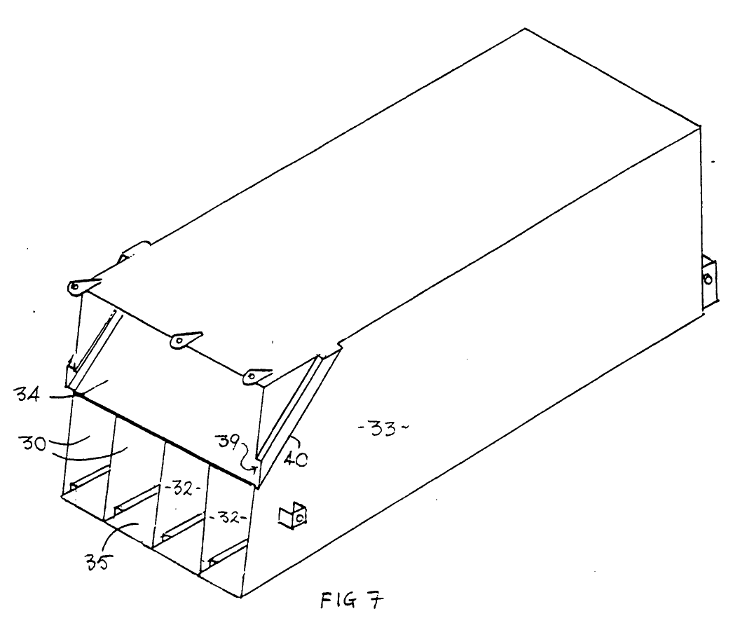

As illustrated in FIG. 7, the main body has four longitudinally extending compartments 30. Each compartment is intended to receive a separate category of recyclable and refuse such as wet garbage, dry garbage, cans, bottles, newspaper, leftover food and so on. Longitudinally extending partitions 32 within the main body as well as the side walls 33 of the main body define the side walls of the compartments. A downwardly sloping upper wall 34 defines the upper limit of the compartments at the rear of the main body.

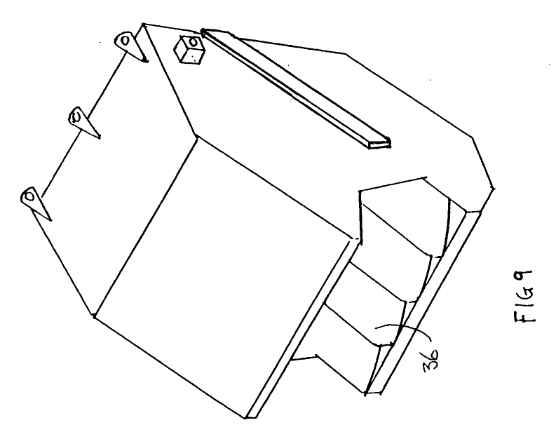

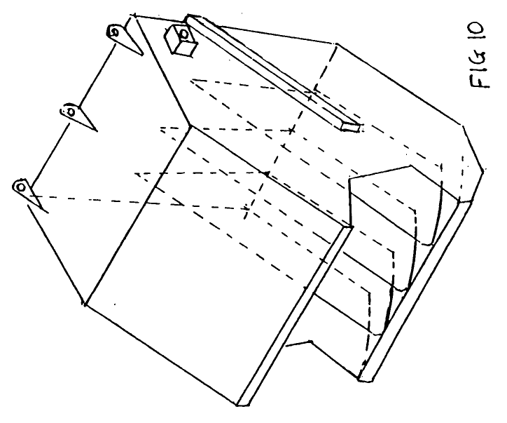

Each compartment 30 opens into a separate area on the loading floor 35 of the hopper and, as illustrated in FIGS. 2, 9 and 10, those areas are separated by dividers 36 which are coplanar with partitions 32 within the main body (FIG. 7).

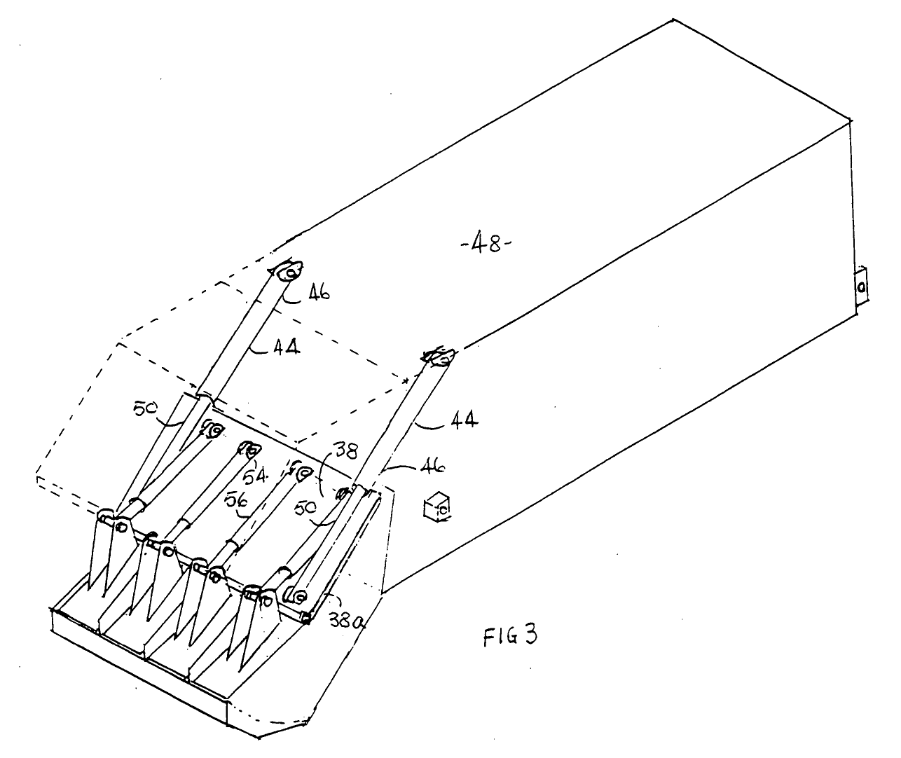

The means by which recyclables and refuse is transferred or “swept” from the loading floor to the compartments within the main body is described first with reference to FIGS. 3, 5 and 7. An extension plate 38 is slidably mounted on upper wall 34 and has side edges 38a which slide in a slot 39 formed in each side wall 33 of the main body. The slots are illustrated in FIG. 7 and each is defined by the flanges and web of a channel 40 attached to the outer surface of each side wall 33.

Each channel slopes downwardly toward the hopper and terminates at like channels 42 which are attached to the outer surface of the side walls of the hopper when the hopper is in the loading position illustrated in FIG. 2. Channels 42 likewise define slots in the side wall of the hopper so that the side edges of the extension plate are slidable in that slot as well.

Channels 40, 42 are co-axial when the hopper is in the loading position and serve as tracks for the extension plate. The plate is thus slidable from an inner stop position illustrated in FIG. 5 where it is entirely within the main body to an outer stop position illustrated in FIG. 3 where it is entirely within the hopper.

A pair of spaced apart pneumatic or hydraulic actuators 44 cause the extension plate to slide. Each actuator has a cylinder 46 which is hinged to the upper wall 48 of the main body. The pistons 50 of the actuator are pivotally attached to the extension plate 38 adjacent to its forward edge as illustrated in FIG. 3.

With reference to FIG. 5, four sweep blades 52a,b,c and d are pivotally attached to the forward edge of the extension plate. Each blade is mounted above a compartment within the main body when the extension plate is retracted and above the area on the loading floor immediately to the rear of that compartment when the extension plate is extended.

With reference to FIG. 3, attached to the upper wall of each blade is a pair of spaced ears 54 and to the ears a piston of a hydraulic or pneumatic actuator 56 is pivotally attached. The cylinder of each actuator is pivotally attached to extension plate 38. The actuators serve to cause the blades to rotate from an upper position illustrated by blade 52d in FIG. 5 to a lower position illustrated by the remaining blades.

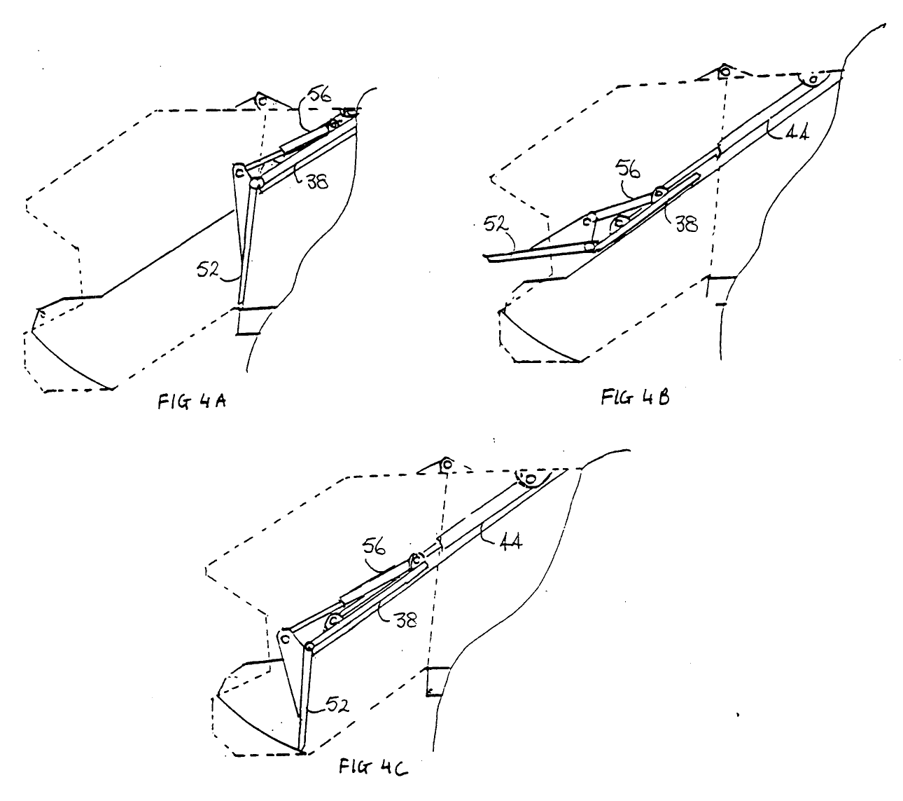

The operation of the sweep blades is described with reference to FIGS. 4A-C. With reference first to FIG. 4A, the piston of actuator 56 is fully extended and sweep blade 52 is in the lower position. The blade is adjacent to the mouth of a compartment in the main body of the truck where the blade prevents the contents of the compartment from discharging.

In FIG. 4B, the piston of actuator 44 is fully extended, the extension plate 38 is at the outer stop position and the blade is within the hopper. The piston of actuator 56 is fully retracted and blade 52 is in the upper position.

In FIG. 4C, the piston of actuator 56 is fully extended and the blade has pivoted to the lower position. The lower edge of the blade is adjacent to the loading floor of the hopper. When extension plate 38 is retracted by means of actuator 44, the blade pushes or sweeps any matter on the loading floor into the compartment in the main body. When the blade reaches the position illustrated in FIG. 4A it has reached it furthest inward extent and extension plate 38 has reached the inner stop position. The blade has thus moved all the matter on the loading floor into the main body of the truck.

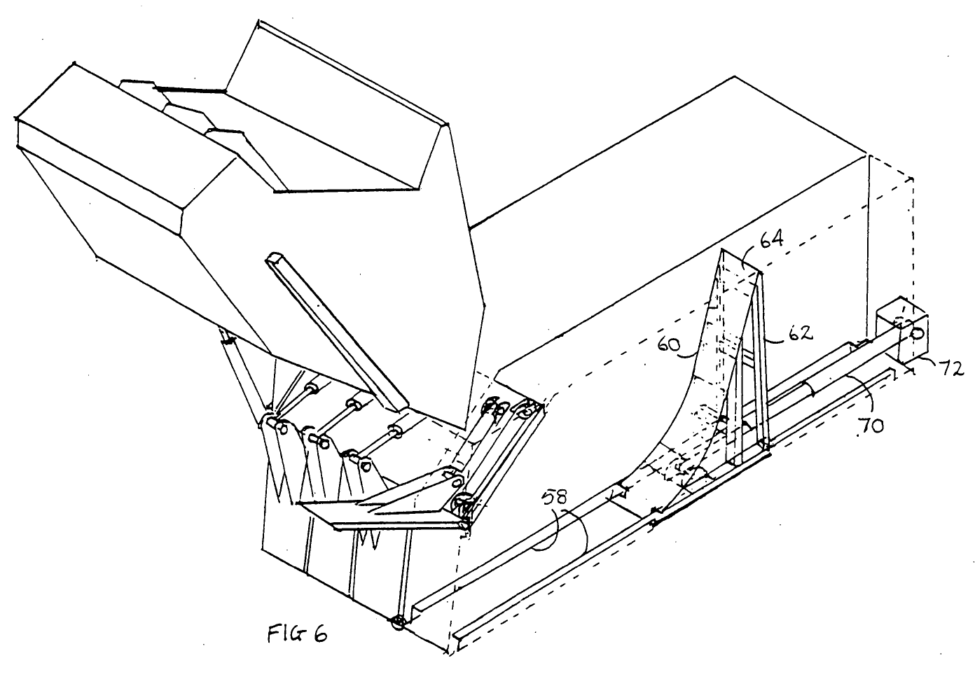

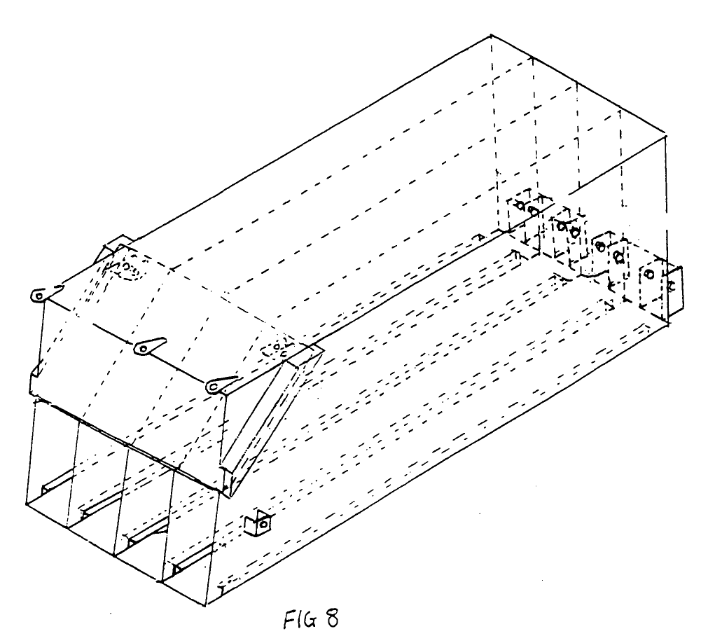

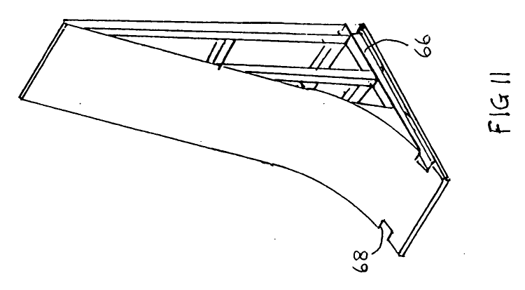

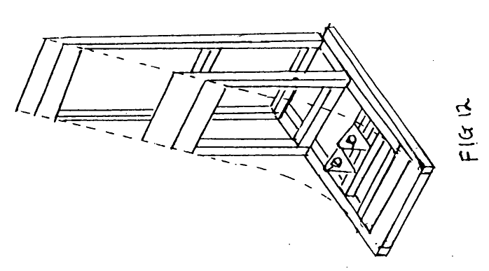

With reference to FIGS. 6 and 8, a pair of spaced longitudinally extending channels 58 are formed on the floor of each compartment within the main body of the truck. The channels serve as a track for a ram 60 having a frame 62 on which an ejector blade 64 is mounted. The ram is illustrated in detail in FIGS. 11 and 12. Runners 66 are formed at the bottom of the frame and those runners slide in the channels. Grooves 68 are formed near the bottom of the blade for receipt of the upper flanges of the channels.

An actuator 70 is attached to a lug 72 on the floor the compartment and its piston is attached to the ram. As the piston extends from the position illustrated in FIG. 6, the ram pushes the contents of the compartment to the opening at the rear of the main body where it discharges from the main body of the truck.

It will be understood of course that modifications can be made in the recyclable and refuse collector of the invention without departing from the scope of the invention as described and claimed herein.

1. A vehicle for receipt and discharge of separate matter including: a loading floor for receipt of the separate matter; a container having a compartment for the separate matter, said compartment having an opening in communication with said loading floor and an end wall spaced apart from said opening; a sweep blade associated with said container; and means for causing said blade to move between inner and outer stop positions, said blade, when moving from said inner stop position, extending outwardly and terminating at said outer stop position at which said blade is in contact with any separate matter on said loading floor, said blade, when moving from said outer stop position, retracting inwardly through said opening and toward said inner stop position with resulting sweeping of any separate matter so contacted toward said end wall, said blade, when in said inner stop position being located such as to prevent any separate matter within said compartment from discharging thorough said opening.

2. The vehicle of claim 1 wherein said container is longitudinally extending and said end wall is spaced longitudinally apart from said opening, said sweep blade being caused to move longitudinally between said inner and outer stop positions, said blade, when moving from said inner stop position travelling longitudinally outwardly and terminating at said outer stop position at which said blade is in contact with any separate matter on said loading floor, said blade, when moving from said outer stop position, retracting longitudinally inwardly toward said inner stop position.

3. The vehicle of claim 1 further including a hopper pivotally connected to said container and with which said loading floor is associated; said hopper being pivotal from a loading position in which the separate matter is adapted to be loaded onto said loading floor to an unloading position in which the separate matter is adapted to be unloaded from said container, said loading floor opening into said compartment when the hopper is in the loading position.

4. The vehicle of claim 1 wherein said container has a plurality of compartments and said vehicle is provided with one only said hopper.

5. The vehicle of claim 1 further including an extension plate about which said blade pivots, means for causing said plate to slide longitudinally with resulting movement of said blade between said inner and outer stop positions.

6. The vehicle of claim 5 wherein said extension plate is slidable from within said compartent to within said hopper.

7. A vehicle for receipt and discharge of waste composed of recyclables and refuse including:
a container having a plurality of compartments for said waste; a hopper pivotally connected to said container and having a loading floor, said hopper being pivotal from a loading position in which the waste is adapted to be loaded onto said loading floor to an unloading position in which the waste is adapted to be unloaded from said container, said loading floor opening into said compartment when the hopper is in the loading position; a sweep blade associated with said container; and means for causing said blade to move between inner and outer stop positions, said blade, when in said inner stop position being located such as to prevent any refuse and recyclables within said compartment from discharging therefrom, said blade, when moving from said inner stop position extending outwardly of said container and terminating at said outer stop position at which said blade is in contact with any waste on said loading floor, said blade, when moving from said outer stop position, retracting inwardly toward said container with resulting sweeping of any waste so contacted into said compartment.

8. A vehicle for receipt and discharge of separate matter comprising: a container having a plurality of compartments for the separate matter; a hopper pivotally connected to said container and having a loading floor, said hopper being pivotal from a loading position in which the separate matter is adapted to be loaded onto said loading floor to an unloading position in which the separate matter is adapted to be unloaded from said compartments, said loading floor opening into each said compartment when the hopper is in the loading position; a sweep blade associated with each said compartment, and means for causing said blades to move between inner and outer stop positions, said blades, when at said outer stop position contacting any separate matter on said loading floor, said blades, when moving from said outer stop position, retracting toward said compartments with resulting sweeping of any separate matter so contacted into said compartments.

9. The vehicle of claim 8 wherein each said blade, when in said inner stop position, being located such as to prevent any separate matter within a separate said compartment from discharging therefrom.

10. The vehicle of claim 8 further including an extension plate about which said blade pivots, means for causing said plate to slide longitudinally with resulting movement of said blade between said inner and outer stop positions.

11. The vehicle of claim 10 wherein said extension plate is slidable from within said compartent to within said hopper.
